(19) United States
(12) Patent Application Publication
(10) Pub. No.: US 2011/0210187 A1
(43) Pub. Date: Sep. 1, 2011

(54) Automatic Sprinkler and Irrigation System

(75) Inventors: Dennis Noble, Moorpark, CA (US); Zhiyong Ke, Shanghai (CN)

(73) Assignee: ANCTECHNOLOGY, Moorpark, CA (US)

(21) Appl. No.: 12/488,570

(22) Filed: Jun. 21, 2009

(51) Int. Cl. B05B 12/08

(52) U.S. Cl. 239/63

(57) ABSTRACT

The present invention provides an irrigation system that allows user to input two soil moisture levels, i.e., the Dry Value and the Wet Value, by conducting a manual watering cycle, i.e., turning on the valves through a Controller when the soil needs watering and turning off the valves when the soil is sufficiently wet. The Controller keeps the soil moisture between the Dry and Wet Values by automatically turning on the valves when the soil moisture reaches the Dry Value, and turning off the valves when soil moisture reaches the Wet Value, at the user-determined desirable watering time periods of the day. In larger areas, the ground could be divided into multiple zones. The Controller could apply different Dry and Wet Values to different zones. The system's simplicity is further enhanced by the solar powered wireless moisture sensors.

### CROSS REFERENCE TO RELATED APPLICATIONS

This application was previous filed in the People's Republic of China with Application Number 2007101727244 on Dec. 21, 2007.

### FIELD OF INVENTION

The present invention concerns a novel sprinkler and irrigation system that allows users to input two soil moisture levels, i.e., the Dry Value and the Wet Value, and automatically keeps the soil moisture between those two said values.

### BACKGROUND OF THE INVENTION

Because water is scarce in many parts of the world, conservation is one of the most important issues facing many countries. Take landscape irrigation for example. According to landscape architects, many homeowners actually weaken their lawns with excessive water. Since landscape irrigation accounts for approximately 50% of the water used externally by homeowners and businesses, the potential for water conservation clearly exist. Because this system may be used in large areas, automatic opening and closing of valves will save labor, and allow for more frequent and shorter watering cycles.

Simplicity of the irrigation systems is the key for the success of water conservation because simpler systems cost less and, more importantly, simpler systems require less skill and attention of the users.

### DESCRIPTION OF RELATED ART

Many sprinkler and irrigation control systems have existed in the art. Traditionally, irrigation is conducted by manual control. The users control the irrigation amount manually by manually opening and closing the valves. Numerous inventions are made to improve such manual process. A timer on the irrigation prevents excessive watering by late closing of the valves. Soil moisture sensors are implemented to control the start of the irrigation. Other inventions use the moisture sensor reading to end of the irrigation to prevent over-watering.

Much of the complexity of the prior art comes from the attempts to objectively use the sensor to achieve certain levels of soil moisture. For example, U.S. Pat. No. 4,922,433 devised a way to set the values by waiting twenty minutes for a valid wet reading (“a valid wet reading is one that is approximate five Kilo-ohms of resistance less than the dry reading,” see Column 4, lines 38-40, U.S. Pat. No. 4,922,433). The problem for the controller to be involved in the determination of valid dry and wet reading may frustrate some users. For instance, if the sensor is installed at a wrong place, the reading may not reach the required level after 20 minutes. Furthermore, the said invention is timer-based as “[the sensor] reading is used to calculate each zone's duration for this irrigation cycle. The system does this by calculating a percentage of time to water (from 0 to 100) of the original duration now stored in memory for each zone.” (See Column 4, lines 62-66, U.S. Pat. No. 4,922,433.)

### SUMMARY OF THE INVENTION

The present invention recognizes following facts. First, it is not a precise science to achieve the optimum amount of watering in either the irrigation or sprinkler systems. Second, different plants or same plants in different periods may require different moisture levels. Third, the users of irrigation or sprinkler systems typically have the ability to determine whether the soil is so dry that watering is needed (i.e., the Dry Value) or wet enough to stop watering (i.e., the Wet Value) by observations independent of Moisture Sensor readings. The simplicity of the present invention is accomplished by giving the users the complete power to determine the proper soil moisture levels by allowing the user, at any time, to run a manual cycle by manually turning on the Controller and the valves when the user determines that the soil moisture level is at the Dry Value, and turning off the valves when the user determines that the soil moisture level is at the Wet Value. After the Controller learns the two values and stores them in a memory device, e.g., EEPROM, it will check the soil moisture level. If the soil moisture level reaches the Dry Value, the Controller will turn on the valves during the next user-determined desirable watering time period of the day, and turn off the valves when the soil moisture level reaches the Wet Value. The Controller thereby keeps the soil moisture level between the Dry and Wet Values.

The absolute reading of the Moisture Sensors, in the present invention, is unimportant. If the Moisture Sensors are installed in an area or a depth that only an insufficient amount of water reach or that water reaches the Moisture Sensors slowly, the Controller merely turns off the valves at a lower reading. Conversely, if the Moisture Sensors are installed in the area that the water reaches easily, the absolute Wet Value held in the Controller will simply be higher. Regardless the absolute Wet Value held by the Controller, the Controller keeps the soil moisture between the levels set by the user.

Since the present invention does not make the absolute moisture reading important, users never need to involve themselves with matters such as quantitative moisture measurements, measured in any technical way, either directly or indirectly, e.g., the ohm readings of the moisture sensors, and any technical matters related to quantitative moisture measurements, e.g., any requirements in terms of absolute quantitative moisture measurements.

In the human endeavor of water conservation, the most important factor in determining success is the degree of public acceptance. The most distinguishing character of the present invention and prior art is that the present invention is simpler, thereby creating low-cost and easy-to-operate systems for wide acceptance. With the aforementioned simplicity, further simplification measures can be applied to adept the system to various users.

To cost sensitive users, the system may be simply comprised of the Controller that is connected to the Moisture Sensors by hardwire.

For less cost sensitive users, the Moisture Sensors may be powered by solar cells, communicating wirelessly with the Controller. Such embodiment eliminates the wiring needs entirely and increases freedom for user to choose the location of the Moisture Sensors. In this embodiment, the installation is simply the installation of the Controller near the valves and the insertion of the solar powered wireless Moisture Sensors into the soil. This embodiment is especially advantageous for large irrigation areas.

In conclusion, the present invention accomplishes the simplicity by (1) having users set the Dry and Wet Values and (2) using the said two values to control the watering.

### BRIEF DESCRIPTION OF THE DRAWINGS

FIG. 1 is the block diagram of the invention in wired embodiment.

FIG. 2 shows the structure of wired embodiment.

FIG. 3 is the block diagram of the invention in wireless embodiment.

FIG. 4 shows the multiple zone embodiment.

### DETAILED DESCRIPTION OF THE PREFERRED EMBODIMENT

The present invention includes a Controller, Magnetic Valves, and Moisture Sensors. The Controller includes a microcontroller, data storage device, input/output interfaces, keypads, LED indicators, and beeper. The Controller controls Magnetic Valves through a valve controller and communicates with Moisture Sensors through either wired or wireless means. The Controller controls the Magnetic Valves by sending electronic pulse signal to latching solenoids. The Moisture Sensors communicate with Controller through an A/D converter.

This embodiment uses Soil Moisture Repellence (SWR) moisture sensors.

The microcontroller runs software that takes the Dry and Wet Values from user input, turns on the Magnetic Valves when the Moisture Sensor reading is at the Dry Value, and turns off the Magnetic Valves when the Moisture Sensor reading is at the Wet Value.

The system is powered by solar cells. After a battery charge controller, current from the solar cells are used to charge a group of NiMH rechargeable batteries. A 5V regulator regulates the voltage before the power is supplied to the microcontroller.

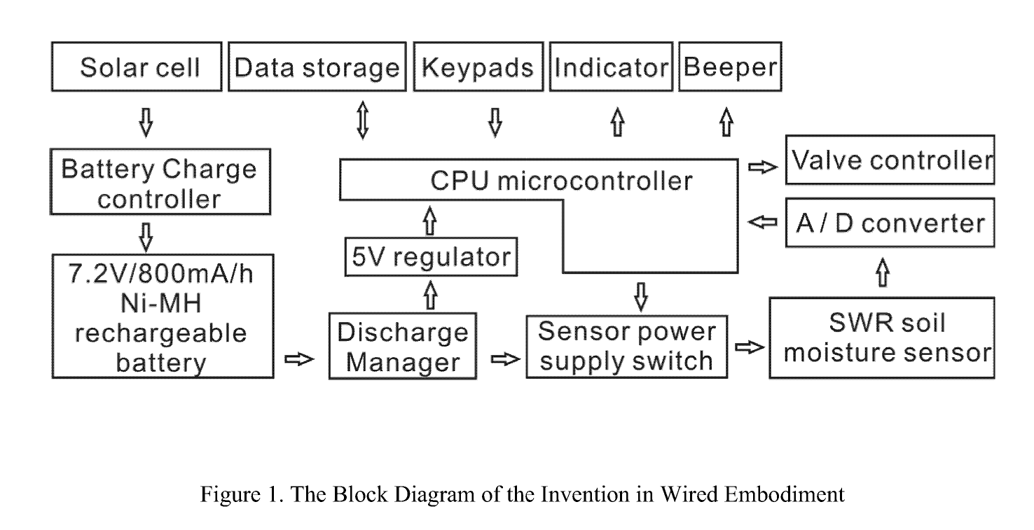

The data storage that is connected to the microcontroller is EEPROM. (See FIG. 1.)

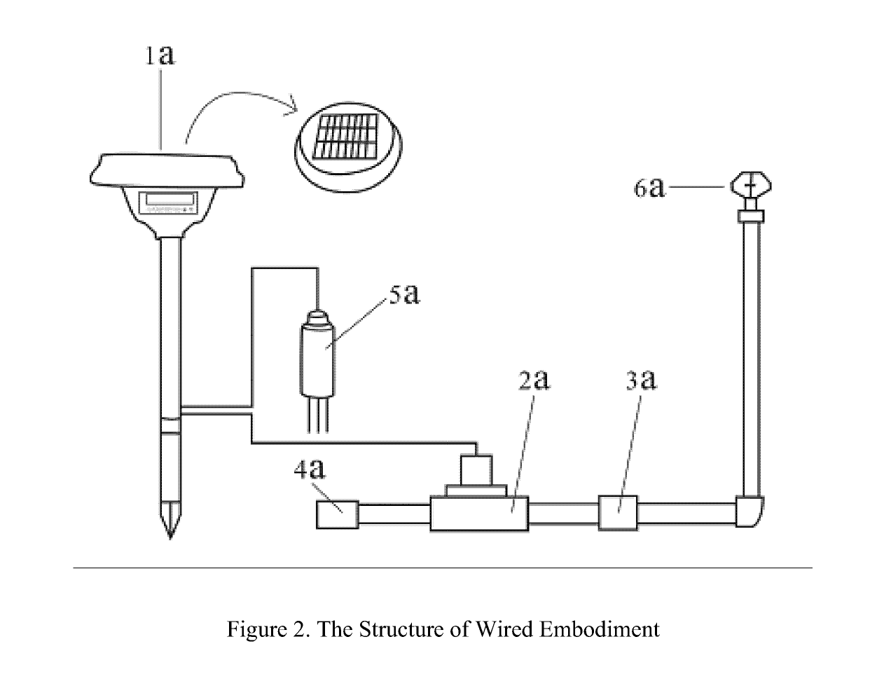

FIG. 2 shows the structure of wired embodiment, which includes the Controller (1a), which contains the solar cells and is connected to Magnetic Valves (5a). Through a latching solenoid, the Controller (1a) controls the Magnetic Valve (2a), which is connected to input pipe (4a) and output pipe (3a), which is connected to sprinkler (6a).

When the Controller is turned on, LED light is turned on, indicating that the device is on. The entire device is powered by the 7.2V/800 mA/h Ni-MH rechargeable battery group. First, the user sets up the desirable watering time periods of the day by using the keypad. Next, the user turns on the Magnetic Valves when watering is needed. The Controller records the Dry Value in EEPROM. Third, the user turns off the Magnetic Valves. The Controller records the Wet Value in EEPROM. Fourth, the Controller compares the Moisture Sensor reading with the Dry Value to determine whether to turn on the Magnetic Valves. Last, the Controller compares the Moisture Sensor reading with the Wet Value to determine whether to turn off the Magnetic Valves.

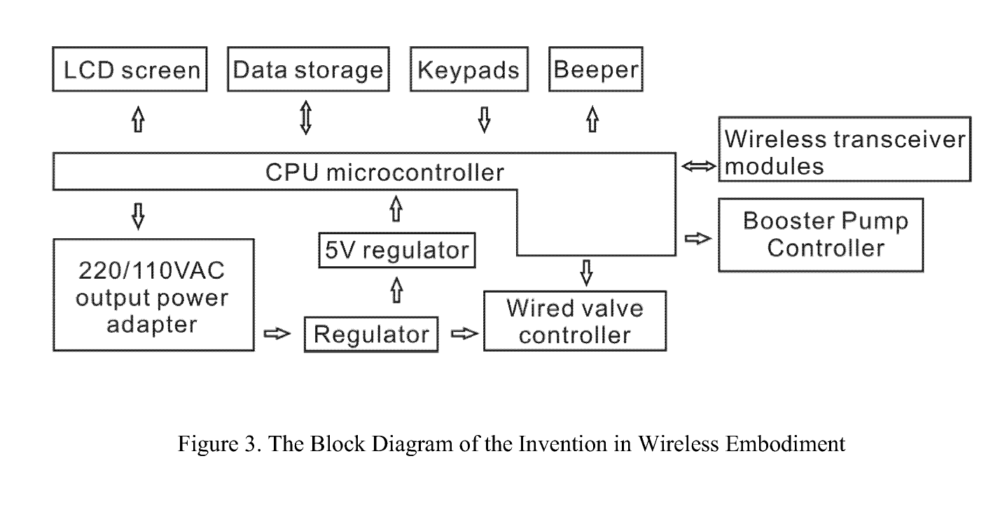

In the wireless application, the microcontroller is connected to a wireless transceiver module to communicate with the Moisture Sensors using RF communication. The system may also be configured to communicate with the Magnetic Valves wirelessly. See FIG. 3.

The wired embodiment is suitable for small areas, e.g., home gardens. The wireless embodiment is suitable for larger areas, e.g., farms. Solar cells make this system easy to install. The absence of power lines may be a welcoming feature for some implementations, as it cost less to install and there is no need to maintain the power lines.

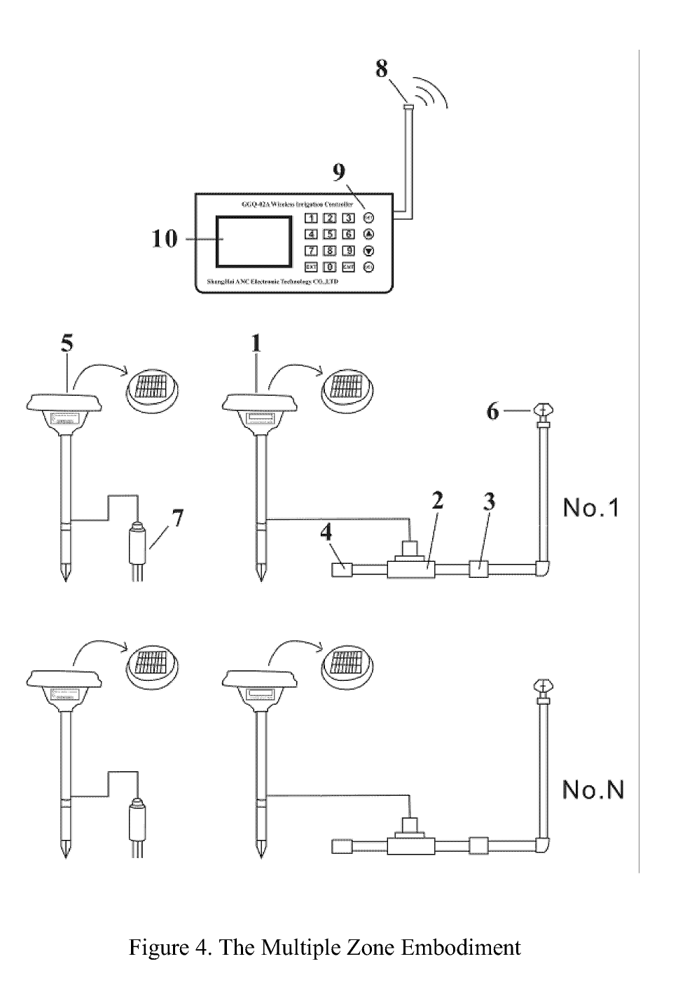

In the embodiment shown FIG. 4, the Controllers control separate groups of Moisture Sensors and Magnetic Valves. The Controllers distinguish different groups by their ID code. Each group is controlled independently through the keypad, which is comprised of the display (10), keypad (9), and antenna (8).

What is claimed is:

1. A sprinkler and irrigation system that is, in each zone, controlled by a controller that allows users to input a Dry Value, which is the soil moisture level when watering is needed, and a Wet Value, which is the soil moisture level when watering is to be stopped, and keeps the soil moisture level between the Dry and Wet Values, comprising
a. a soil moisture sensing means for each zone to detect the soil moisture;
b. a control means to turn on and turn off valves;
c. a solid state memory means to hold the Dry and Wet Values;
d. the controller that allows users to set the Dry and Wet Values, gets the soil moisture reading from the soil moisture sensing means, and controls the valves through the control means;
e. a means for the controller to communicate with the soil moisture sensing means;
f. a means for the controller to communicate with the control means;
g. a means to supply power to the controller.

2. The sprinkler and irrigation system according to claim 1, where the soil moisture sensing means is SWR moisture sensors.

3. The sprinkler and irrigation system according to claim 1, where the control means is latching solenoid.

4. The sprinkler and irrigation system according to claim 1, where the solid state memory means is EEPROM.

5. The sprinkler and irrigation system according to claim 1, where the means for the controller to communicate with the soil moisture sensing means is by hardwiring.

6. The sprinkler and irrigation system according to claim 1, where the means for the controller to communicate with the soil moisture sensing means is accomplished wirelessly.

7. The sprinkler and irrigation system according to claim 6, where the controller communicates with designated soil moisture sensing means by ID code.

8. The sprinkler and irrigation system according to claim 1, where the means for the controller to communicate with the control means is by hardwiring.

9. The sprinkler and irrigation system according to claim 1, where the means for the controller to communicate with the control means is accomplished wirelessly.

10. The sprinkler and irrigation system according to claim 9, where the controller communicates with designated control means by ID code.

11. The sprinkler and irrigation system according to claim 1, where controller turns on valves when both the soil moisture sensing means is below the Dry Value and the time is within the user-determined desirable watering time periods of the day.

12. The sprinkler and irrigation system according to claim 1, where the user sets the Dry and Wet Values by manually turn on and off the valves through the controller.
